(19) United States
(12) Patent Application Publication
(10) Pub. No.: US 2021/0062632 A1
(43) Pub. Date: Mar. 4, 2021

(54) BLENDING SYSTEM FOR FRACTURING FLUID

(71) Applicant: Solaris Oilfield Site Services Operating LLC, Houston, TX (US)

(72) Inventor: Bryan Scott Lambert, The Woodlands, TX (US)

(21) Appl. No.: 17/097,100

(22) Filed: Nov. 13, 2020

Related U.S. Application Data
(63) Continuation-in-part of application No. 16/392,435, filed on Apr. 23, 2019, now Pat. No. 10,836,568.
(60) Provisional application No. 62/960,310, filed on Jan. 13, 2020.

(51) Int. Cl. E21B 43/26; B01F 15/04

(52) U.S. Cl. CPC E21B 43/2607; B01F 2003/1257; B01F 15/0416; B01F 15/0445

(57) ABSTRACT

Embodiments of the present invention include a blending system that delivers granular material directly from designated storage containers into a blender based on the liquid flow rate into the blender and the blender slurry flow rate exiting the blender. The blending system utilizes a blender controller system in communication with a blender slurry flow meter, a blender liquid flow meter, a conveyor load cell, a conveyor motor, and a conveyor speed sensor, wherein the blender control system is configured to regulate the amount of granular material entering the hopper based on the entrance rate of liquid into the blender and the exit rate of the fracturing fluid slurry from the blender.

### CROSS REFERENCE TO RELATED APPLICATIONS

This application claims priority to pending U.S. patent application Ser. No. 16/392,435 filed Apr. 10, 2019 and entitled “A Blender Hopper Control System for Multi-Component Granular Compositions.” This application also claims priority to U.S. Provisional Patent Application Ser. No. 62/960,310 filed Jan. 13, 2020 and entitled “Blending System for Fracturing Fluid.”

### BACKGROUND OF THE INVENTION

### Field of the Invention

The present invention relates to a blending system that delivers granular material directly from designated storage containers into a blender based on the liquid flow rate into the blender and the blender slurry flow rate exiting the exiting the blender. The blending system utilizes a blender controller system in communication with a blender slurry flow meter, a blender liquid flow meter, a conveyor load cell, a conveyor motor, and a conveyor speed sensor, wherein the blender control system is configured to regulate the amount of granular material entering the hopper based on the entrance rate of liquid into the blender and the exit rate of the fracturing fluid slurry from the blender.

### Description of the Related Art

Granular materials, such as sand, are used in bulk quantities in a number of applications. For example, mining companies sometimes make use of a technique termed “hydraulic fracturing” to aid in the extraction of fossil fuels from well sites. Hydraulic fracturing is the propagation of fractures in a rock layer caused by the presence of a pressurized fracturing fluid.

The main purposes of fracturing fluid are to extend fractures, add lubrication, change gel strength, and to carry proppant into the formation. There are two main types of fracturing fluid for transporting proppant generally referred to as high-rate and high-viscosity. High-viscosity fracturing tends to cause large dominant fractures, while high-rate fracturing causes small spread-out micro-fractures. Typical fracturing fluids are a slurry of water (from about 85-95%), sand/proppant (from about 8-10%), and chemical additives (from about 0.2-0.8%).

Since large quantities of fracturing fluid are used at a fracturing site there is an ongoing need for an efficient on-site storage of materials and an efficient blending system for blending the fracturing fluid.

### SUMMARY OF THE INVENTION

Embodiments of the present invention include a blending system that delivers granular material directly from designated storage containers into a blender based on the liquid flow rate into the blender and the blender slurry flow rate exiting the The blending system utilizes a blender controller system in communication with a blender slurry flow meter, a blender liquid flow meter, a conveyor load cell, a conveyor motor, and a conveyor speed sensor, wherein the blender control system is configured to regulate the amount of granular material entering the hopper based on the entrance rate of liquid into the blender and the exit rate of the fracturing fluid slurry from the blender.

One embodiment of the present invention is a blending system for blending fracturing fluid comprising: (a) a blender that blends a granular material and a liquid into a fracturing fluid slurry; (b) a blender liquid flow meter that measures an entrance rate of liquid into the blender; (c) a blender slurry flow meter that measures an exit rate of the fracturing fluid slurry; (d) a storage container, wherein the storage container contains a granular material; (e) a conveyor having a first end positioned under a bottom exit of a storage container and a second end positioned over the blender, wherein the conveyor is run by a conveyor motor; (f) a conveyor load cell positioned under the second end of the conveyor; (g) a conveyor speed sensor; and (h) a blender controller in communication with the blender slurry flow meter, the blender liquid flow meter, the conveyor load cell, the conveyor motor, and the conveyor speed sensor, wherein the blender control system is configured to regulate the amount of granular material entering the hopper based on an entrance rate of a liquid into the blender and the exit rate of the fracturing fluid slurry from the blender.

Another embodiment of the present invention is a blending system for blending fracturing fluid comprising: (a) a blender that blends a granular material and a liquid into a fracturing fluid slurry, wherein the blender has a top end and a bottom end; (b) a blender liquid flow meter that measures an entrance rate of liquid into the blender, wherein the liquid enters the blender proximal the top end of the blender; (c) a blender slurry flow meter that measures an exit rate of the fracturing fluid slurry, wherein the slurry exits the blender proximal the bottom end of the blender; (d) at least one storage container, wherein the storage container contains a granular material; (e) a conveyor having a first end positioned under a bottom exit of the storage container and a second end positioned over the blender, wherein the conveyor is run by a conveyor motor having a rotor with a speed of rotation adjustable by a blender controller, and wherein the granular material travels directly from the silo, to the first end of the conveyor, to the second end of the conveyor, into a funnel attached to the top end of the blender, and into the top end of the blender; (f) a conveyor load cell positioned under the second end of the conveyor; (g) a conveyor speed sensor; and (h) the blender controller in communication with the blender slurry flow meter, the blender liquid flow meter, the conveyor load cell, the conveyor motor, and the conveyor speed sensor, wherein the blender control system is configured to regulate the amount of granular material entering the hopper based on an entrance rate of the liquid into the blender and the exit rate of the fracturing fluid slurry from the blender.

Yet another embodiment of the present invention is a method of blending a fracturing fluid comprising: (a) installing a blending system at a well site, wherein the blending system comprises (i) a blender that blends a granular material and a liquid into a fracturing fluid slurry; (ii) a blender liquid flow meter that measures an entrance rate of liquid into the blender; (iii) a blender slurry flow meter that measures an exit rate of the fracturing fluid slurry; (iv) a storage container, wherein the storage container contains a granular material; (v) a conveyor having a first end positioned under a bottom exit of a storage container and a second end positioned over the blender, wherein the conveyor is run by a conveyor motor; (vi) a conveyor load cell positioned under the second end of the conveyor; (vii) a conveyor speed sensor; and (viii) a blender controller in communication with the blender slurry flow meter, the blender liquid flow meter, the conveyor load cell, the conveyor motor, and the conveyor speed sensor, wherein the blender control system is configured to regulate the amount of granular material entering the hopper based on an entrance rate of liquid into the blender and the exit rate of the fracturing fluid slurry from the blender; (b) adding the granular material into the storage container; (c) entering a ratio of the amount of the granular material to a volume of the fluid to be blended into the fracturing fluid slurry into the blender controller; (d) calculating a rate of entry of the mass of the granular material into the blender; (e) pumping the fluid into the blender; (e) coordinating the delivery of the granular material and the entry of the fluid into the blender to achieve the ratio of the weight of granular material to the volume of fluid entered into the blender controller; and (e) blending the granular material and the liquid into the fracturing fluid slurry.

The foregoing has outlined rather broadly several aspects of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed might be readily utilized as a basis for modifying or redesigning the structures for carrying out the same purposes as the invention. The foregoing has outlined rather broadly several aspects of the present invention in order that the detailed description of the invention that follows may be better understood.

### BRIEF DESCRIPTION OF THE DRAWINGS

Appended Figures depict certain non-limiting embodiments of the storage and blending system and related systems. The figures are not intended to limit the scope of the invention but, instead, are intended to provide depictions of specific embodiments, features and non-limiting characteristics of the systems described herein. The accompanying figures further illustrate the present invention. The components of an embodiment shown in the drawings are not necessarily drawn to scale, emphasis instead being placed upon clearly illustrating the principles of the present invention.

FIG. 1 depicts a schematic representation of one embodiment of a blending system for blending fracturing fluid slurry.

FIG. 2 depicts one embodiment of a storage system for granular materials showing a set of three silos vertically positioned on each of two parallel base platforms.

FIG. 3 depicts a plan view of the embodiment of the blending system illustrated in FIG. 2.

FIG. 4 depicts a perspective view from one end of the embodiment of the blending system illustrated in FIG. 2.

FIG. 5 depicts a perspective view of the embodiment of the blending system illustrated in FIG. 2 without the storage containers.

### DESCRIPTION OF THE PREFERRED EMBODIMENTS

The present invention relates to a blending system that delivers granular material directly from designated storage containers into a blender based on the liquid flow rate into the blender and the blender slurry flow rate exiting the blender. The system includes the control and management of on-site storage containers for each of the granular materials used, the regulation of the delivery of specified quantities of each granular material to the blender, the regulation of the liquid entering the blender, the coordination of the flow of granular materials and liquid into the blender, and the flow rate of the blended liquid fracturing fluid slurry.

Unless specifically defined herein, all technical and scientific terms used have the same meaning as commonly understood by one of ordinary skill in the art to which this invention belongs. The term “granular material” is used to define a flowable material comprising solid macroscopic particles, such as sand, gravel, or the like. The term “proppant” is used to define a granular material used in drilling, for example by oil and gas industries. Proppant comprises appropriately sized and shaped particles which may be mixed with fracturing fluid for use in a hydraulic fracturing treatment. A proppant is a material such as naturally occurring grains of sand of a predetermined size, or engineered materials, such as resin-coated sand, ceramic materials, sintered bauxite, or the like.

As used herein, the term “about” refers to a +/−10% variation from the nominal value. It is to be understood that such a variation is always included in a given value provided herein, whether or not it is specifically referred to.

As used herein, the term “device” is an apparatus configured to perform a particular function.

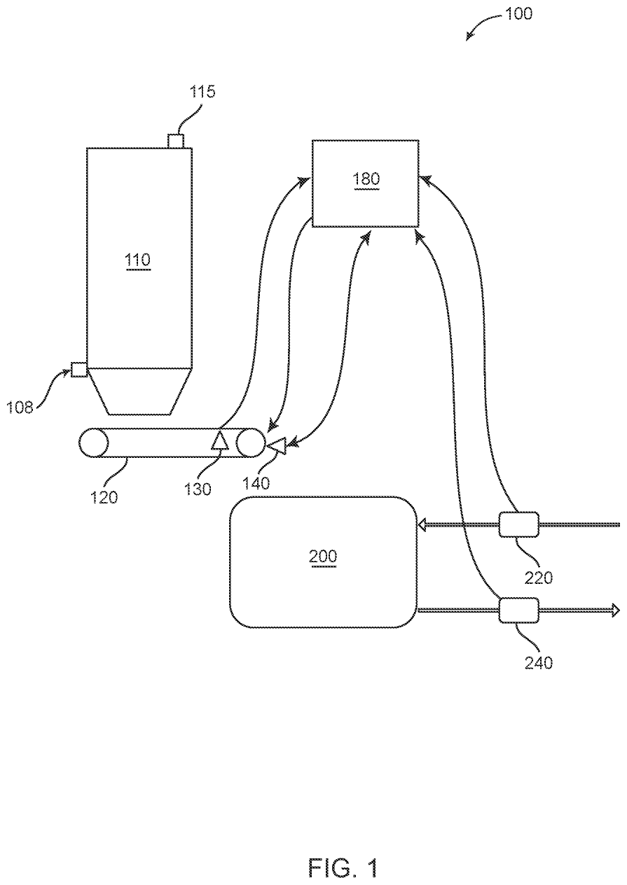

A schematic representation of one aspect of the blending system 100 as described herein is shown in FIG. 1. The blender 200 blends granular materials (also referred to herein as proppant and/or sand) and liquid materials (generally including water and chemicals) to form a fracturing fluid. The granular materials are stored in storage containers 110 (also referred to herein as silos) with one type of granular material stored in a designated storage container 110. The level of material in each storage container is monitored using a container level probe 115 and/or a silo load cell 108.

The material from a silo exits the silo through a discharge exit, such as a gate valve, onto a proximal end of a conveyor 120. The conveyor 120 has a load cell 130 under the distal end of the conveyor distal to the discharge exit. The conveyor 120 also has a speed sensor 140 that measures the speed of the conveyor 120. A blender controller 180 determines the amount of material passing over the distal end of the conveyor into the blender from the silo load cell readings and the speed sensor readings by totaling the weight of material passing over the load cell per a set time period.

The blender controller 180 controls the speed of the conveyor based on the amount of granular material required to enter the blender per a set time period. The entry rate of granular material into the blender is based on the entry rate of fluid into the blender and a programmable set point of solid/fluid ratio. The entry rate of fluid into the blender 200 is based on the flow rate of fluid as measured by the blender fluid flow meter 220. The blender then blends the granular material and fluid to form a fracturing fluid slurry. The blending process is typically performed by a mixing process that is designed to quickly and thoroughly mix the contents of the blender using a mixing device inside the blender.

Managing the Inventory of Blend Materials at the Site

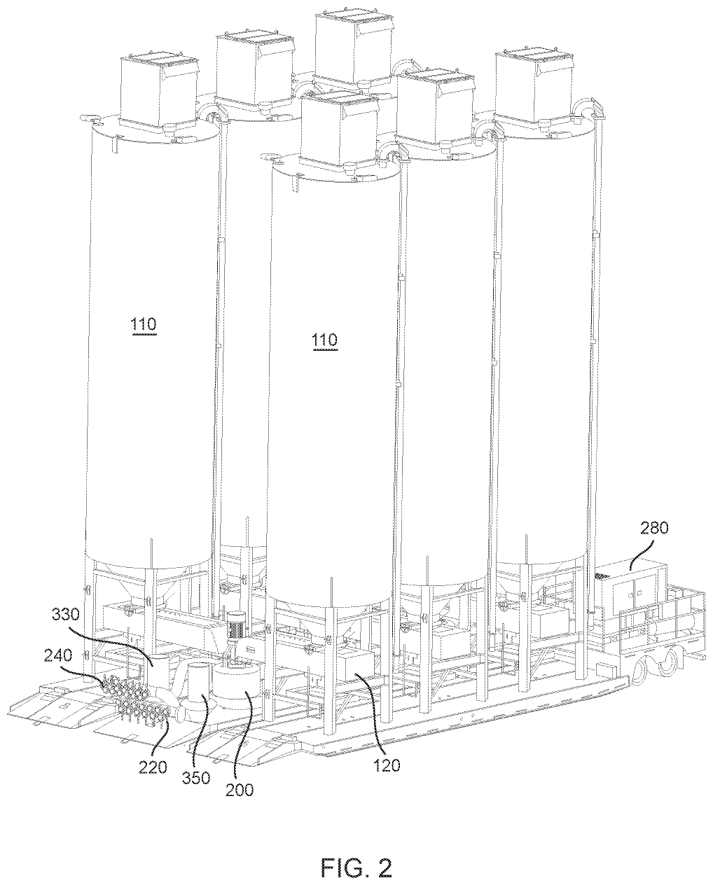

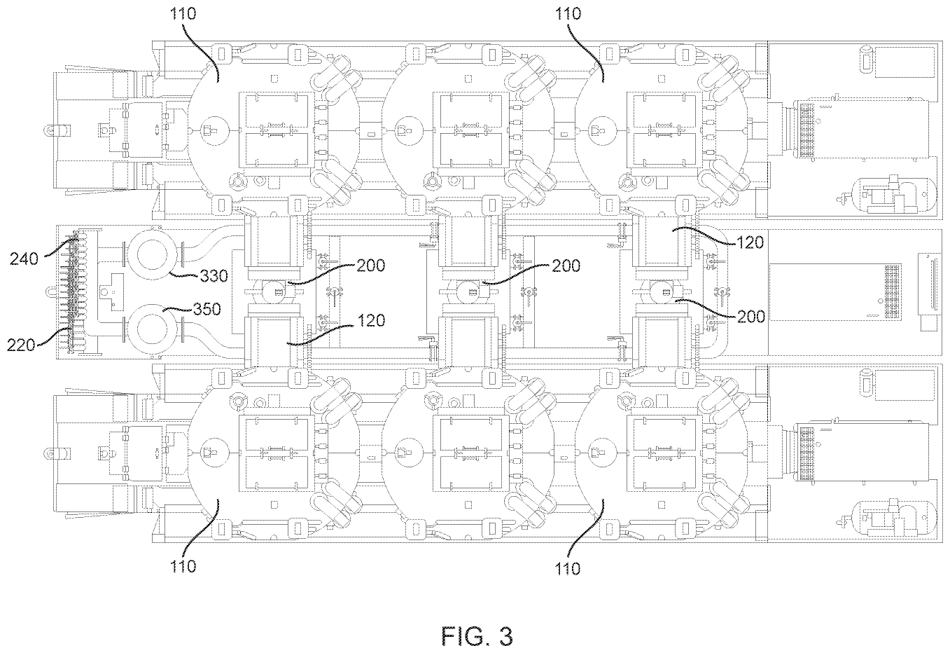

One embodiment of a storage system with silo type storage containers is illustrated in FIGS. 2-3. The storage system includes a plurality of mobile storage containers 110, also referred to herein as silos, arranged on a base platform. FIG. 2 shows a perspective view of two parallel base platforms where each base platform has three vertically standing silos 110 with their legs secured to the base platform. The platform typically has an operational section 280 with an attached power generator.

Since each silo of the on site storage system depicted in FIG. 2 provides a separate storage compartment, the operator can house a particular material in one or more silos. The inventory of material in each silo 110 may be constantly monitored with one or more devices. The monitoring devices may be sonic, radar, optical, inductive or mechanical level monitors. For example, load cells 108 or strain gauges attached to the silo legs may be used to weigh the contents of the silo. Another example of a monitoring device is a level monitor 115, such as a pulsed radar monitor positioned inside a silo 110 at the top portion of the silo. The pulsed radar on the top of the silo is used to detect the profile of the granular component in the silo, as it takes the angle of repose of the component into consideration and calculates an effective level, or weight, of the component in the silo.

Measuring the contents is useful for inventory management, determining and controlling the rate of usage, and avoiding over filling or unexpected empty containers. Preferred embodiments determine real time variations in the level, volume or weight of the contents of the silos and transmit the level of component in the silo to a programmable logic control unit (PLC) that can automatically slow or stop the outflow of component from a particular silo at a pre-determined level, switch silo flows to ensure the uninterrupted flow of the component, or initiate the refilling of the silo to maintain the silo level of component within predetermined limits.

Managing Inflow/Outflow of Blend Materials to the Blender

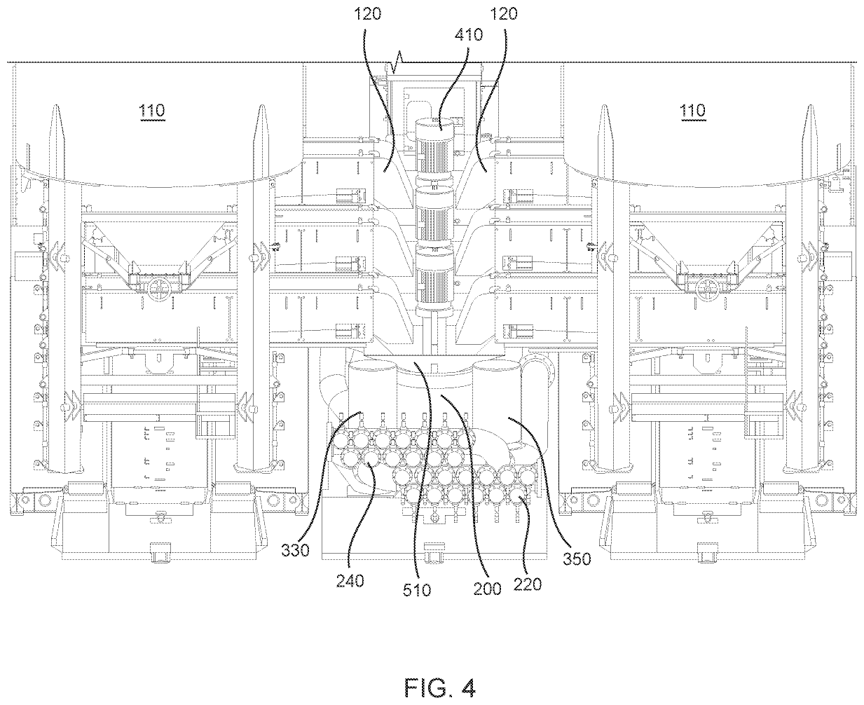

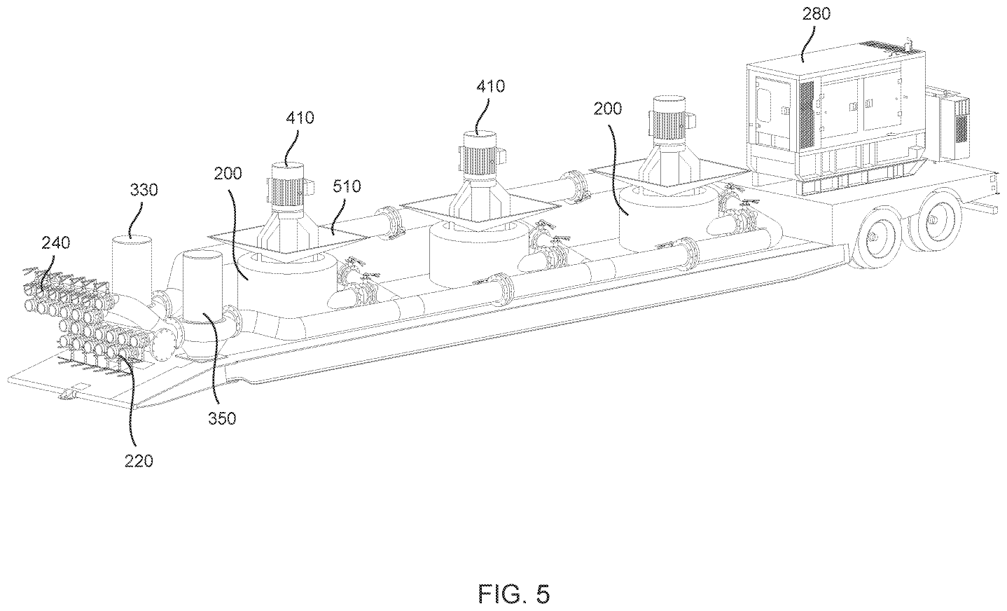

The blending system 100 delivers granular material directly from designated storage containers into a blender based on the liquid flow rate into the blender and the blender slurry flow rate exiting the blender. The embodiment of the blending system 100 illustrated in FIGS. 3-5 shows a blender 200 positioned below a distal end of two conveyors 120. The granular material from one or two storage containers 110 is dispersed onto the proximal end of the conveyor 120. The distal end of each conveyor 120 empties the granular material directly into a funnel 510 that guides the material into the top of the blender 200.

It is important that there is tight control over the exact amount of granular material entering the blender. This is accomplished using readings from a load cell 130 under the distal end of the conveyor, where the load cell is calibrated for the desired number of pounds of granular material per foot of conveyor. A speed sensor 140 measures the speed of the conveyor 120. A blender controller 180 determines the exact amount of material passing over the distal end of the conveyor into the blender from the silo load cell readings and the speed sensor readings by totaling the weight of material passing over the load cell per a set time period. If the speed of the conveyor needs to be adjusted, the blender controller can adjust the rpm of the conveyor motor.

The blender controller 180 controls the speed of the conveyor 120 based on the amount of granular material required to enter the blender per a designated time period. The entry rate of granular material into the blender is controlled to match the entry rate of fluid into the blender to meet a programmable set point of solid/fluid ratio. The entry rate of fluid into the blender 200 is controlled by a suction pump 330 and measured by the blender fluid flow meter 220.

The set point is predetermined by the nature of the slurry required by the driller for a particular well. It will typically set the pounds of granular material per gallon of fluid that make up the slurry that is pumped into the well. Once the granular material and the fluid enter the blender 200, the blender blends the granular material and fluid to form the fracturing fluid slurry.

The blending process is typically performed by a mixing process that is designed to quickly and thoroughly mix the contents of the blender using a mixing device inside the blender. One embodiment of the blending process uses an impeller 410 designed to ensure that all of the material entering the blender is quickly blended into a homogenous fracturing fluid slurry.

For example, one or two types of granular material may enter the blender at a certain rate (i.e., pounds per minute). The granular material enters the funnel 510 at the top of the blender. The fluid is pumped into the blender 200 by the suction pump 330 relatively close to the top of the blender so that the fluid and the granular material are well mixed by the time they are pumped out of the bottom part of the blender by the discharge pump 350. The exit rate for the fracturing slurry is controlled by a discharge pump 350 that provides an adequate charge pressure for the frac pump that pumps the fracturing slurry into the well. The exit rate of the fracturing slurry is measured by the blender slurry flow meter 240.

Advantages of the Blender System

The blending system 100 removes the need for the traditional hopper blender that is used to premix the granular materials before they enter the blender. Currently, the blend granular mixture enters the blender 200 using screw augers that transfer the granular mixture from the hopper into the blender. By removing the use of the hopper blender and screw auger, there is a significant reduction in airborne dust and sand. Furthermore, the blending system 100 has a reduced footprint at the blending site.

The foregoing provides a detailed description of the invention which forms the subject of the claims of the invention. It should be appreciated by those skilled in the art that the general design and the specific embodiments disclosed might be readily utilized as a basis for modifying or redesigning the natural gas supply system to perform equivalent functions, but those skilled in the art should realized that such equivalent constructions do not depart from the spirit and scope of the invention as set forth in the appended claims.

What is claimed is:

1. A blending system for blending fracturing fluid comprising:
(a) a blender that blends a granular material and a liquid into a fracturing fluid slurry;
(b) a blender liquid flow meter that measures an entrance rate of liquid into the blender;
(c) a blender slurry flow meter that measures an exit rate of the fracturing fluid slurry;
(d) a storage container, wherein the storage container contains a granular material;
(e) a conveyor having a first end positioned under a bottom exit of a storage container and a second end positioned over the blender, wherein the conveyor is run by a conveyor motor;
(f) a conveyor load cell positioned under the second end of the conveyor;
(g) a conveyor speed sensor; and
(h) a blender controller in communication with the blender slurry flow meter, the blender liquid flow meter, the conveyor load cell, the conveyor motor, and the conveyor speed sensor, wherein the blender control system is configured to regulate the amount of granular material entering the hopper based on an entrance rate of a liquid into the blender and the exit rate of the fracturing fluid slurry from the blender.

2. The blending system of claim 1, wherein the blender controller adjusts the speed of the conveyor by adjusting the rotations per minute a rotor of the conveyor motor.

3. The blending system of claim 1, further comprising a funnel attached to a top end of the blender.

4. The blending system of claim 3, wherein the granular material travels directly from the silo, onto the first end of the conveyor, to the second end of the conveyor, into the funnel, and into the top end of the blender.

5. The blending system of claim 4, wherein the liquid enters the blender proximal the top end of the blender.

6. The blending system of claim 5, further comprising an impeller that blends the granular material and the liquid as they enter the blender into the fracturing fluid slurry.

7. The blending system of claim 1, wherein the exit rate of the fracturing fluid slurry is controlled by a discharge pump.

8. The blending system of claim 1, wherein the entry rate of the fluid into the blender is controlled by a suction pump.

9. The blending system of claim 1, further comprising a storage container monitoring device that dynamically monitors a level, mass, or amount of the granular material contained in the storage container.

10. The blending system of claim 1, wherein the blender controller calculates an amount of granular material passing over the second end of the conveyor into the blender from the load cell readings and the speed sensor readings by totaling a weight of the material passing over the load cell per a set time period.

11. The blending system of claim 10, wherein the blender controller in coordination with the conveyor load cell governs the delivery rate of the granular material into the blender.

12. The blending system of claim 1, wherein the blender controller matches the amount of fracturing fluid slurry exiting the blender with the amount of granular material and liquid entering the blender.

13. The blending system of claim 1, wherein the liquid flow meter measures the entrance rate of water and chemicals into the blender.

14. A blending system for blending fracturing fluid comprising:
(a) a blender that blends a granular material and a liquid into a fracturing fluid slurry, wherein the blender has a top end and a bottom end;
(b) a blender liquid flow meter that measures an entrance rate of liquid into the blender, wherein the liquid enters the blender proximal the top end of the blender;
(c) a blender slurry flow meter that measures an exit rate of the fracturing fluid slurry, wherein the slurry exits the blender proximal the bottom end of the blender;
(d) at least one storage container, wherein the storage container contains a granular material;
(e) a conveyor having a first end positioned under a bottom exit of the storage container and a second end positioned over the blender, wherein the conveyor is run by a conveyor motor having a rotor with a speed of rotation adjustable by a blender controller, and wherein the granular material travels directly from the silo, to the first end of the conveyor, to the second end of the conveyor, into a funnel attached to the top end of the blender, and into the top end of the blender;
(f) a conveyor load cell positioned under the second end of the conveyor;
(g) a conveyor speed sensor; and
(h) the blender controller in communication with the blender slurry flow meter, the blender liquid flow meter, the conveyor load cell, the conveyor motor, and the conveyor speed sensor, wherein the blender control system is configured to regulate the amount of granular material entering the hopper based on an entrance rate of the liquid into the blender and the exit rate of the fracturing fluid slurry from the blender.

16. The blending system of claim 15, wherein the blender controller in coordination with the conveyor load cell governs the delivery rate of the granular material into the blender.

17. The blending system of claim 15, wherein the blender controller in coordination with a pair of conveyor load cells in communication with a pair of conveyors in communication with a pair of opposed storage containers controls the total delivery rate of the granular material from one or both of the storage containers based on the entrance rate of liquid into the blender and the exit rate of the fracturing fluid slurry from the blender

18. A method of blending a fracturing fluid comprising:
(a) installing a blending system at a well site, wherein the blending system comprises
(i) a blender that blends a granular material and a liquid into a fracturing fluid slurry;
(ii) a blender liquid flow meter that measures an entrance rate of liquid into the blender;
(iii) a blender slurry flow meter that measures an exit rate of the fracturing fluid slurry;
(iv) a storage container, wherein the storage container contains a granular material;
(v) a conveyor having a first end positioned under a bottom exit of a storage container and a second end positioned over the blender, wherein the conveyor is run by a conveyor motor;
(vi) a conveyor load cell positioned under the second end of the conveyor;
(vii) a conveyor speed sensor; and
(viii) a blender controller in communication with the blender slurry flow meter, the blender liquid flow meter, the conveyor load cell, the conveyor motor, and the conveyor speed sensor, wherein the blender control system is configured to regulate the amount of granular material entering the hopper based on an entrance rate of liquid into the blender and the exit rate of the fracturing fluid slurry from the blender;
(b) adding the granular material into the storage container;
(c) entering a ratio of the amount of the granular material to a volume of the fluid to be blended into the fracturing fluid slurry into the blender controller;
(d) calculating a rate of entry of the mass of the granular material into the blender;
(e) pumping the fluid into the blender;
(e) coordinating the delivery of the granular material and the entry of the fluid into the blender to achieve the ratio of the weight of granular material to the volume of fluid entered into the blender controller; and
(e) blending the granular material and the liquid into the fracturing fluid slurry.
